(19) United States
(12) Patent Application Publication
(10) Pub. No.: US 2008/0293021 A1
(43) Pub. Date: Nov. 27, 2008

(54) Foreign Language Voice Evaluating Method and System

(76) Inventor: Sung-ok Jang, Gyeonggi-do (KR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/097,549

(22) PCT Filed: Mar. 15, 2007
(86) PCT No.: PCT/KR2007/001275

§ 371 Date: Jun. 16, 2008

(30) Foreign Application Priority Data
Mar. 16, 2006 (KR) 10-2006-0024512

(51) Int. Cl. G09B 19/06

(52) U.S. Cl. 434/157

(57) ABSTRACT

Disclosed are a foreign language oral test method and a system in which a non-native speaker can evaluate a vocal answer of a learner. An education server of the method includes providing at least one of foreign language questions to a leaner computer and receiving and recording the vocal answer corresponding to the provided foreign language question; displaying a plurality of evaluation references such that a non-specialist for foreign language can evaluate the vocal answer of the learner; reproducing a required vocal answer for the provided foreign language question and the recorded vocal answer of the learner; and storing any one of the evaluation references selected by an evaluator who listens to the required vocal answer and the vocal answer of the learner.

### BACKGROUND OF THE INVENTION

1. Field of the Invention

The present invention relates to an oral test for a foreign language, and more particularly, to an oral test method of enabling a non-native speaker to test the conversation ability of a learner who studies a foreign language and a system for performing the same.

2. Description of the Related Art

Different from a conventional way for learning a foreign language regardless of the learner's ability, such as studying a foreign language using a CD in which learning contents are stored, or a textbook, at present, most of learners accesses various Internet sites which provide various foreign language studying contents to study a foreign language thanks to propagation of Internet. The most important point in learning a foreign language will be how to precisely express learner's thought and indention to a counterpart and a hearing study of correctly understanding what the counterpart speaks.

However, according to most of the foreign language learning sites presently provided through the Internet, the conversation ability of the learners is automatically tested by a predetermined program, or evaluated by specialists (native speakers) having plenty of knowledge of their language who are asked to test the learner's oral conversation ability. Thus, in a case of automatically testing as described above, only the test result is provided to the learner, so that the learner cannot precisely understand his/her fault and occasionally goes through following steps. When the specialists are asked to carry out the learner's oral test for foreign language, the learner can receive the test result only after the learner takes the test and a predetermined time has lapsed, and high fees must be paid to the specialists.

### SUMMARY OF THE INVENTION

Therefore, the present invention has been made in view of the above problems, and it is an aspect of the present invention to provide a foreign language oral test method enabling a non-specialist (non-native speaker) of a foreign language to easily test an oral conversation ability of a learner to speak the foreign language, and a system for performing the same.

In accordance with an aspect of the present invention, the above and other objects can be accomplished by the provision of a foreign language oral test method implemented by a learner computer and an education server to provide foreign language questions and to evaluate vocal answers of a learner corresponding to the foreign language questions, the education server comprising: providing at least one of the foreign language questions to the leaner computer, and receiving and recording the vocal answer corresponding to the provided foreign language question; displaying a plurality of evaluation references such that a non-specialist for foreign language can evaluate the vocal answer of the learner; reproducing a required vocal answer for the foreign language question and the recorded vocal answer of the learner; and storing any one of the evaluation references selected by an evaluator who listens to the required vocal answer and the vocal answer of the learner.

Moreover, the plurality of evaluation references comprises: a fluency-evaluation reference for evaluating whether pronunciation and a sentence-type vocal answer of the learner are correctly matched to a pronunciation and a sentence of the required vocal answer; a correctness evaluation reference for evaluating a case when the pronunciation and the sentence of the vocal answer of the learner are not correctly matched to the pronunciation and the sentence of the required vocal answer, but the sentences are matched to each other; a phrase evaluation reference for evaluating a case when the sentence-type vocal answer of the learner is an incomplete sentence; a vocabulary evaluation reference for evaluating a case when the vocal answer of the learner consists of only vocabulary; a wrong answer evaluation reference for evaluating a case when there is the vocal answer of the learner but nothing is matched to the pronunciation and the sentence of the required vocal answer; and a no-answer evaluation reference for evaluating a case when there is no the vocal answer of the learner.

Therefore, according to the present invention, plural evaluation references of testing a vocal answer to a question provided to the learner are provided to evaluator so that the non-specialist (non-native speak) can evaluate the oral conversation ability of the learner using the evaluating references.

### BRIEF DESCRIPTION OF THE DRAWINGS

FIG. 1 is a schematic block diagram illustrating an education server of a foreign language oral test system according to an embodiment of the present invention;

FIG. 2 is an exemplary view illustrating an evaluation screen provided to test the oral conversation ability of a foreign language according to an embodiment of the present invention; and

FIGS. 3 and 4 are flowcharts illustrating a foreign language oral testing method according to an embodiment of the present invention.

### DESCRIPTION OF THE PREFERRED EMBODIMENTS

Hereinafter, the embodiments of the present invention will be described in detail with reference to the accompanying drawings. In the following description of the present invention, if the detailed description of the already known structure and operation may confuse the subject matter of the present invention, the detailed description thereof will be omitted.

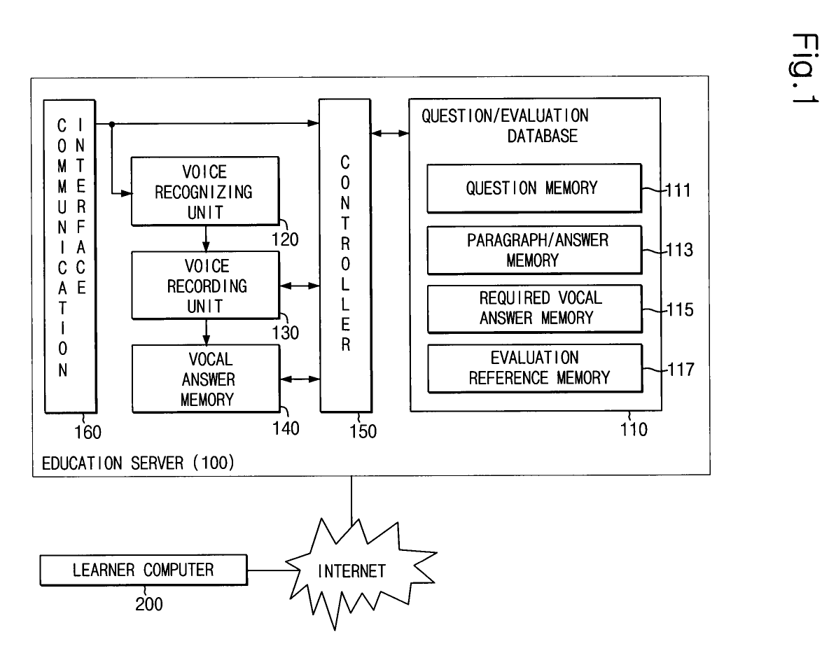

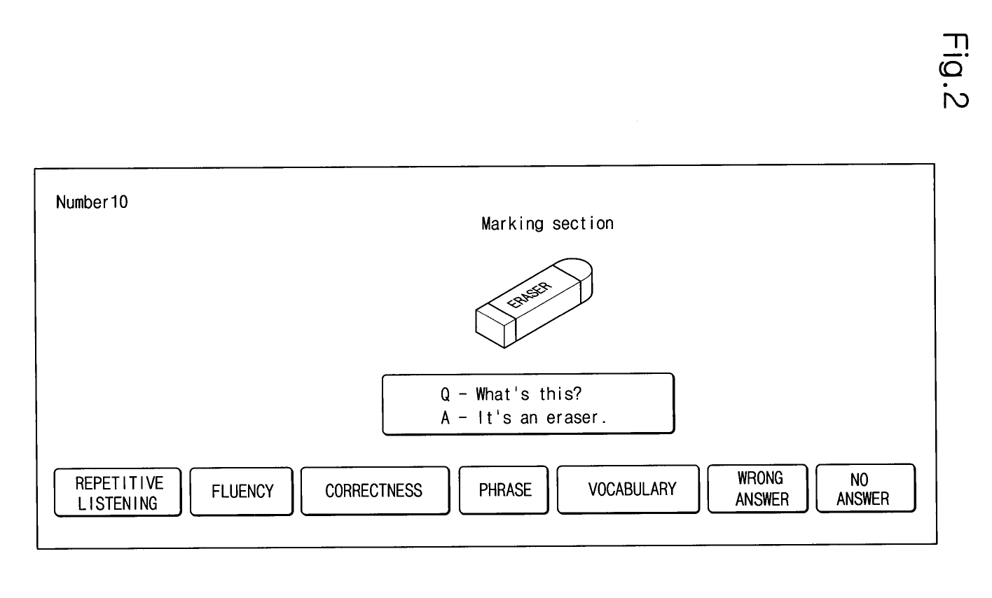

FIG. 1 is a schematic block diagram illustrating an education server of a foreign language oral test system according to an embodiment of the present invention, and FIG. 2 is an exemplary view illustrating an evaluation screen provided to test the oral conversation ability of a foreign language according to an embodiment of the present invention.

First, referring to FIG. 1, an education server 100 of a foreign language oral conversation ability testing system according to an embodiment of the present invention includes a question/evaluation database 110 to store motion picture type foreign language questions and corresponding paragraphs, required sentence-type vocal answers, required vocal answers, and plural evaluation references, a voice recognizing unit 120 to recognize the vocal answers of a learner, a voice recording unit 130 to record the vocal answers of the learner, a vocal answer memory 140 to store the vocal answers of the learner, and a controller 150 to control overall processes of providing questions and evaluations.

The question/evaluation database 110 stores data required to provide the questions and the evaluation of the vocal answer of the learner, and includes a question memory 111, a paragraph/answer memory 113, a required vocal answer memory 115, and an evaluation reference memory 117.

The question memory 111 stores a plurality of foreign language questions by various themes according to the age and level of the leaner. The foreign language questions may be questions containing a vocal question such as ‘What is this?’ and a corresponding motion picture. Thus, the learner checks the motion picture (image) and the vocal question provided by the education server 100 to listen and view and speaks an answer corresponding to the provided motion picture and the vocal question.

The paragraph/answer memory 113 stores text type paragraphs and the required sentence-type vocal answers, corresponding to at least one foreign language question stored in the question memory 111, for example, such as a paragraph ‘What is this?’ and a required sentence-type vocal answer ‘It's an eraser.’ The required vocal answer memory 115 stores a required vocal answer (correct vocal answer of a native speaker) corresponding to at least foreign language question stored in the question memory 111.

The evaluation reference memory 117 stores a plurality of evaluation references with which a non-specialist (non-native speaker) of the foreign language can easily evaluate the vocal answer of the learner. In more detail, the evaluation reference memory 117 stored a fluency-evaluation reference of evaluating the vocal answer of the learner when pronunciations and a sentence of the vocal answer of the learner are precisely matched to pronunciations and a sentence of the required vocal answer, and a correctness evaluation reference of evaluation the vocal answer of the learner when the vocal answer of the learner is not precisely matched to the pronunciations of the required vocal answer but is matched to the sentence of the required vocal answer.

Moreover, the evaluation reference memory 117 further stores a phrase evaluation reference of evaluating the vocal answer of the learner when the sentence of the vocal answer of the learner is imperfect, a vocabulary evaluation reference of evaluating the vocal answer of the learner when the vocal answer of the learner consists of only vocabularies, a wrong answer evaluation reference of evaluating the vocal answer of the learner when there is the vocal answer of the learner but there is nothing matched to the pronunciations and the sentence of the required vocal answer, and a no-answer evaluation reference of evaluating the vocal answer of the learner when there is no the vocal answer of the learner.

The voice recognizing unit 120 receives and recognizes the vocal answer of the learner transmitted from a learner computer 200 through the Internet, and the voice recording unit 130 records the vocal answer of the learner recognized by the voice recognizing unit 120 according to a recording control command of the controller 150 described later. Since the learner must answer the provided foreign language question within a predetermined answer time in the foreign language oral test according to the embodiment of the present invention, the voice recording unit 130 continuously records the no-answer state for the predetermined answer time even when there is no the vocal answer of the learner to be recognized by the voice recognizing unit 120. Meanwhile, the vocal answer memory 140 stores the vocal answer of the learner recorded by the voice recording unit 130 to correspond to number corresponding to the provided foreign language question.

The controller 150 controls the education server 100, for example, accessing of at least one foreign language question according to a theme selected by the learner from the question memory 111 to provide the selected foreign language question to the learner computer 200, recording of the vocal answer of the learner corresponding to the provided foreign language question, and outputting of the record controlling command for the record of the no-answer state for the predetermined answer time even when there is no the vocal answer of the learner to the voice recording unit 130. After that, when the recording of the vocal answer of the learner corresponding to the foreign language question provided to the learner is completed and a command is inputted to evaluate the vocal question from the evaluator, the controller 150, as illustrated in FIG. 2, provides a screen for the evaluation to the evaluator.

First, the controller 150 accesses the number corresponding to the foreign language question provided to the learner and a corresponding motion picture from the question memory 111 to display, and accesses the paragraph and the sentence of the required answer corresponding to the foreign language question from the paragraph/answer memory 113 to display. Thus, the evaluator visually checks the motion picture, the paragraph, and the required answer of the foreign language question provided to the learner.

Moreover, the controller 150 accesses the plurality of the evaluation references for the evaluator to easily evaluate the vocal answer of the learner from the evaluation reference memory 117 and displays the accessed evaluation references in the form of icons such that the evaluator can select any one of the evaluation references using a mouse. After that, the controller 150 accesses the required vocal answer corresponding to the foreign language question from the required vocal answer memory 115 to reproduce the accessed required vocal answer, and directly accesses the vocal answer of the learner from the vocal answer memory 140 to reproduce the accessed vocal answer of the learner when the reproduction of the required vocal answer is completed.

At this time, the controller 150 reproduces the required vocal answer and the vocal answer of the learner and repeats the reproduction of the required vocal answer and the vocal answer of the learner when a repetitive listening command is inputted by the evaluator. Thus, the evaluator can repetitively listen to the required vocal answer of the corresponding foreign language question and the vocal answer of the learner, and evaluates the vocal answer of the learner with reference to the displayed plural evaluation references.

For example, when it is determined that the pronunciation and the sentence of the vocal answer of the learner with respect to the corresponding foreign language question are correctly matched to the pronunciation and the sentence of the required vocal answer (correct answer: native speaker's voice), the evaluator evaluates the vocal answer of the learner with respect to the corresponding foreign language question by clicking a fluency-evaluation reference icon for evaluating the vocal answer of the learner when the pronunciation and the sentence of the vocal answer of the learner with respect to the corresponding foreign language question are correctly matched to the pronunciation and the sentence of the required vocal answer. Moreover, when the required vocal answer is ‘It's an eraser’ and the vocal answer of the learner is ‘eraser’, the evaluator clicks a vocabulary evaluation reference for evaluating a case when the vocal answer of the learner consists of only vocabulary to evaluate the vocal answer of the learner with respect to the corresponding foreign language question.

The controller 150 stores the corresponding evaluation results in corresponding to the respective numbers corresponding to the foreign language questions when the evaluator selects any ones of the respective evaluation reference icons corresponding to the respective foreign language questions. When it is determined that the evaluation of the vocal answers of the learner for all the foreign language questions is completed, the controller 150 synthesizes the stored respective evaluation references and automatically estimates the evaluation results to display the evaluation results to the evaluator and to provide the same to the learner computer 200.

On the other hand, the education server 200 further includes a communication interface 160. The communication interface 160 provides the foreign language questions and the evaluation results to the learner computer 200 through the Internet by a command from the controller 150, and receives the vocal answer of the learner from the leaner computer 200.

According to the features of the present invention as described above, since non-native speaker can evaluate the vocal answers to the respective foreign language questions with respect to the plural evaluation references provided by the education server 100, for example, parents of the learner directly evaluate the vocal answer of the learner and explain the incorrect parts of the vocal answer of the learner when the learner completes to answer the provided respective foreign language questions.

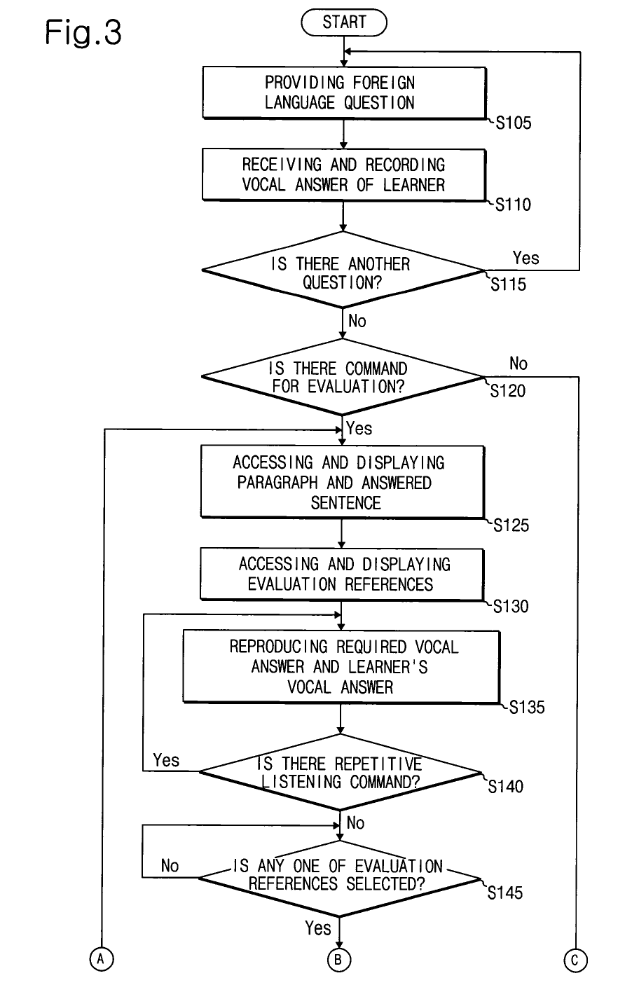

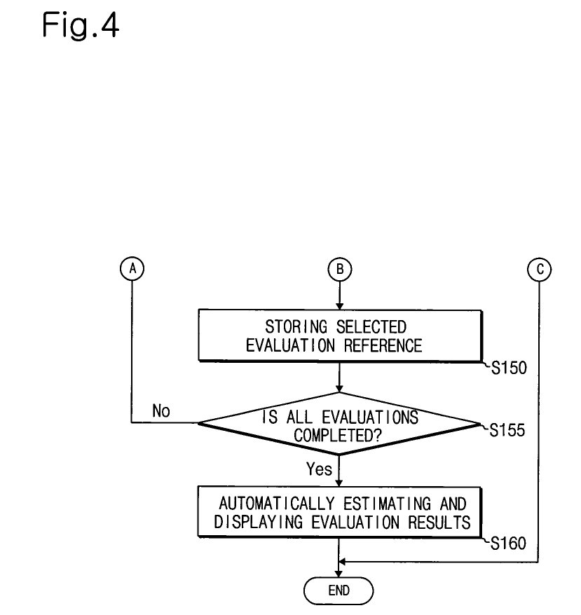

Hereinafter, a foreign language oral test method according to an embodiment of the present invention will be described in detail with reference to FIGS. 3 and 4. FIGS. 3 and 4 are flowcharts illustrating a foreign language oral test method according to an embodiment of the present invention.

First, the controller 150 accesses the foreign language question according to a theme selected by the learner from the question memory 111 to provide the accessed foreign language question to the learner computer 200 (S105), and outputs the recording control command to record the vocal answer of the learner to the voice recognizing unit 120 when the vocal answer of the learner to the provided foreign language question is recognized by the voice recognizing unit 120, such that the vocal answer of the learner is stored in the vocal answer memory 140 to correspond to the provided foreign language question (S110). Moreover, the controller 150 outputs the recording control command to recording the no-answer state for the predetermined time to the voice recording unit 130 even when there is no the vocal answer of the learner to be recognized by the voice recognizing unit 120, and stores the no-answer state in corresponding to the number of the provided foreign language question in the vocal answer memory 140.

After that, the controller 150 determines whether there is a next foreign language question according to the selected theme in the question memory 111 (S115). If there are more foreign language questions, the controller 150 provides the next foreign language questions to the learner computer 200 and repeats the above-described steps (S105 to S115). On the other hand, if there is no more foreign language question, the controller 150 determines whether a command to evaluating the vocal answer of the learner is inputted by the evaluator (S120).

If it is determined that there is the command to evaluate the vocal answer of the learner, the controller 150, as illustrated in FIG. 2, provides a screen for the evaluation to the evaluator. First, the controller 150 accesses the number and the motion picture of the foreign language question, provided to the learner, from the question memory 111 to display, and accesses the paragraph and the required vocal answer corresponding to the provided foreign language question from the paragraph/answer memory 113 to display (S125). Thus, the evaluator visually checks the number, the motion picture, the paragraph, and the required vocal answer of the foreign language question provided to the learner.

In addition, the controller 150 accesses the plural evaluation references, with which the evaluator easily evaluates the vocal answer of the learner, from the evaluation reference memory 117 and displays the accessed evaluation references in the form of an icon such that the evaluator can select one of the evaluation references with a mouse (S130). Hereinafter, since the plural evaluation references are identical to those as described above, the description of the plural evaluation references will be omitted.

After that, when the evaluation screen is completely displayed, the controller accesses and reproduces the required vocal answer corresponding to the provided foreign language question from the required vocal answer memory 115 and accesses the vocal answer of the learner from the vocal answer memory 140 to reproduce the same when the reproduction of the required vocal answer is completed (S140). In addition, the controller 150 determines whether the repetitive listening command is inputted from the evaluator after the reproduction of the required vocal answer and the vocal answer of the learner (S140), and reproduces the required vocal answer and the vocal answer of the learner when the repetitive listening command is inputted. Thus, the evaluator can listen to the required vocal answer and the vocal answer of the learner corresponding to the provided foreign language question repetitively, and can evaluate the vocal answer of the learner according to the displayed plural evaluation references.

On the other hand, when it is determined that the repetitive listening command is not inputted by the evaluator, the controller 150 determines which evaluation icon for the vocal answer of the learner is selected by the evaluator (S145). If the evaluator selects any one of the evaluation icons, the controller 150 stores the corresponding evaluation result to correspond to the number of the provided foreign language question (S150).

For example, when the pronunciation of the vocal answer of the learner to the corresponding foreign language question is not correctly matched to the pronunciation of the required vocal answer (native speaker's correct vocal answer), the evaluator clicks the correctness evaluation reference icon for evaluating a case when the pronunciation of the vocal answer of the learner is not correctly matched to the pronunciation of the required vocal answer but the paragraphs are matched to each other, to evaluate the vocal answer of the learner with respect to the corresponding foreign language question. In another example, when there is no the vocal answer of the learner with respect to the corresponding foreign language question, the evaluator clicks the no-answer evaluation reference icon for evaluating a case when there is no the vocal answer of the learner, to evaluate the vocal answer of the learner with respect to the corresponding foreign language question.

After that, the controller 150 determines whether the evaluation for the vocal answer of the learner with respect to the foreign language provided to the leaner computer 200 is completed (S155). If it is determined that the vocal answer to be evaluated remains, the controller 150 repeats the above-described steps (S125 to S155). However, if it is determined that all the evaluations of the vocal answer of the learner is completed, the controller 150 synthesizes the stored individual evaluation references and automatically estimates the evaluation results to display the evaluation results to the evaluator, or to provide the evaluation results to the learner computer 200 (S160).

As described above, according to the features of the present invention, since non-specialist for foreign language (non-native speaker) can evaluate the vocal answer of a learner according to the plural evaluation references, for example, parents of the learner directly evaluate the vocal answer of the learner and explain the incorrect parts of the vocal answer of the learner when the learner completes to answer the provided respective foreign language questions.

1: A foreign language oral test method implemented by a learner computer and an education server to provide foreign language questions and to evaluate vocal answers of a learner corresponding to the foreign language questions, the method comprising:
providing at least one of the foreign language questions to the leaner computer, and receiving and recording the vocal answer corresponding to the provided foreign language question;
displaying a plurality of evaluation references such that a non-specialist for foreign language can evaluate the vocal answer of the learner;
reproducing a required vocal answer for the foreign language question and the recorded vocal answer of the learner; and
storing any one of the evaluation references selected by an evaluator who listens to the required vocal answer and the vocal answer of the learner.

2: The foreign language oral test method according to claim 1, wherein, the plurality of evaluation references comprises:
a fluency-evaluation reference for evaluating whether pronunciation and a sentence-type vocal answer of the learner are correctly matched to a pronunciation and a sentence of the required vocal answer;
a correctness evaluation reference for evaluating a case when the pronunciation and the sentence of the vocal answer of the learner are not correctly matched to the pronunciation and the sentence of the required vocal answer, but the sentences are matched to each other;
a phrase evaluation reference for evaluating a case when the sentence-type vocal answer of the learner is an incomplete sentence;
a vocabulary evaluation reference for evaluating a case when the vocal answer of the learner consists of only vocabulary;
a wrong answer evaluation reference for evaluating a case when there is the vocal answer of the learner but nothing is matched to the pronunciation and the sentence of the required vocal answer; and
a no-answer evaluation reference for evaluating a case when there is no the vocal answer of the learner.

3: The foreign language oral test method according to claim 1, further comprising:
displaying a paragraph of the foreign language question provided to the learner computer and the sentence of the required vocal answer;
repetitively reproducing the required vocal answer and the vocal answer of the learner when a repetitive listening command is selected by the evaluator listened to the required vocal answer and the vocal answer of the learner; and
automatically estimating and displaying at least one of the stored evaluation references when it is determined that at least one of the foreign language questions is completely evaluated.

4: A foreign language oral test evaluation system comprising:
a learner computer;
an education server to provide a foreign language question and to evaluate a vocal answer of a learner corresponding to the foreign language question, the education server comprising:
a question/evaluation database including a question memory to store at least one of motion picture type foreign language question, a paragraph/answer memory to store a paragraph and a sentence of a required answer which correspond to the foreign language question, a required vocal answer memory to store the required vocal answer corresponding to the foreign language question, and an evaluation reference memory to store the vocal answer of the learner such that a non-specialist for foreign language can evaluate the vocal answer of the learner;
a voice recognizing unit to recognize the vocal answer of the learner transmitted from the learner computer;
a voice recoding unit to record the vocal answer of the learner recognized by the voice recognizing unit;
a vocal answer memory to store the vocal answer of the learner recorded by the voice recording unit; and
a controller to perform:
(a) accessing and displaying the plural evaluation references, the paragraph, and the sentence of the required answer from the evaluation reference memory and the paragraph/answer memory when an evaluation command is inputted;
(b) accessing and reproducing the required vocal answer and the vocal answer of the learner from the required vocal answer memory and a vocal answer memory, respectively; and
(c) storing one of the evaluation references when the evaluator, listened to the required vocal answer and the vocal answer of the learner, selects the one of the evaluation references, and automatically estimating and displaying the stored at least one of the evaluation references when the evaluation for all the foreign language question is completed.

5: The foreign language oral test evaluation system according to claim 4, wherein the plurality of evaluation references comprises:
a fluency-evaluation reference for evaluating whether a pronunciation and a sentence of the vocal answer of the learner are correctly matched to a pronunciation and a sentence of the required vocal answer;
a correctness evaluation reference for evaluating a case when the pronunciation and the sentence of the vocal answer of the learner are not correctly matched to the pronunciation and the sentence of the required vocal answer, but the sentences are matched to each other;
a phrase evaluation reference for evaluating a case when the sentence of the vocal answer of the learner is incomplete;
a vocabulary evaluation reference for evaluating a case when the vocal answer of the learner consists of only vocabulary;
a wrong answer evaluation reference for evaluating a case when there is the vocal answer of the learner but nothing is matched to the pronunciation and the sentence of the required vocal answer; and
a no-answer evaluation reference for evaluating a case when there is no the vocal answer of the learner.

6: The foreign language oral test method according to claim 2, further comprising:
displaying a paragraph of the foreign language question provided to the learner computer and the sentence of the required vocal answer;
repetitively reproducing the required vocal answer and the vocal answer of the learner when a repetitive listening command is selected by the evaluator listened to the required vocal answer and the vocal answer of the learner; and
automatically estimating and displaying at least one of the stored evaluation references when it is determined that at least one of the foreign language questions is completely evaluated.
